(19) United States
(12) Patent Application Publication
(10) Pub. No.: US 2024/0213664 A1
(43) Pub. Date: Jun. 27, 2024

(54) WIDE-ANGLE IMPEDANCE-MATCHING DEVICE FOR RADIATING-ELEMENT ARRAY ANTENNA AND METHOD OF DESIGNING SUCH A DEVICE

(71) Applicants: THALES, MEUDON (FR); CENTRE NATIONAL DE LA RECHERCHE SCIENTIFIQUE, PARIS (FR); UNIVERSITE DE RENNES 1, RENNES CEDEX (FR); NANTES UNIVERSITE, NANTES (FR); INSA DE RENNES, RENNES CEDEX 7 (FR); CENTRALESUPELEC, GIF SUR YVETTE Cedex (FR)

(72) Inventors: Raphael GILLARD, RENNES (FR); Maria GARCIA VIGUERAS, RENNES (FR); Diego BERMUDEZ-MARTIN, RENNES (FR); Hervé LEGAY, PLAISANCE DU TOUCH (FR)

(21) Appl. No.: 18/544,164

(22) Filed: Dec. 18, 2023

(30) Foreign Application Priority Data
Dec. 22, 2022 (FR) 2214203

(51) Int. Cl. H01Q 1/50; H01Q 5/335

(52) U.S. Cl. CPC H01Q 1/50; H01Q 5/335

(57) ABSTRACT

A wide-angle impedance-matching device for a radiating-element array antenna includes a transmission screen having a first surface intended to be positioned facing the radiating-element array parallel to the radiating aperture of the antenna and being configured to match the impedance of the antenna for an H-plane scan, and a set of metal pins placed orthogonally, on at least one surface of the transmission screen, at the intersection of at least some of the respective anti-symmetry planes of the electric field radiated by the antenna for an H-plane scan, for two linear polarizations in two orthogonal directions, the set of metal pins being configured to match the impedance of the antenna for an E-plane scan.

### CROSS-REFERENCE TO RELATED APPLICATION

This application claims priority to foreign French patent application No. FR 2214203, filed on Dec. 22, 2022, the disclosure of which is incorporated by reference in its entirety.

### FIELD OF THE INVENTION

The invention relates to the field of active antennas comprising a radiating-element array and able to synthesize one or more beams that can be pointed in a direction scanning a wide angular sector.

### BACKGROUND

The invention in particular relates to the field of space technology and to the active antennas used in LEO satellites (LEO being the acronym of Low Earth Orbit) belonging to a constellation of satellites intended to deliver telecommunication services to anywhere on Earth. These constellations use either L- or S-band frequencies, or Ku-, Ka- or Q/V-band frequencies for high-throughput telecommunication systems.

More precisely, the invention relates to a wide-angle impedance-matching device for such an active antenna, and to a method for designing such a device.

Active antennas installed in LEO satellites consist of a radiating-element array, the radiating elements of which are connected to amplifiers, and a beamforming device. For an active antenna operating in transmission, the beamformer distributes one or more radio-frequency signals to the various radiating elements after having applied a specific phase and amplitude setting allowing synthesis of a beam in a given direction, and orientation of the radiation pattern of this or these radio-frequency signals. For an active antenna operating in reception, the beamformer combines one or more radio-frequency signals received by the various radiating elements after having applied a specific phase and amplitude setting to optimize reception in a given direction.

The radiating elements must meet the following constraints:
they must be easy to manufacture, in particular in order to minimize manufacturing cost;
they must induce as little radio-frequency loss as possible, in particular in order to minimize the power to be dissipated in a small area;
they must be as compact as possible in order to limit their mass; and they must have a bandwidth compatible with the telecommunication system.

The unit cell of the radiating-element array is subject to two constraints:
it must be as large as possible in order to minimize the number of radiating elements; and
it must be smaller than a value dₘₐₓ so that the effect of the periodicity does not result in the appearance of grating lobes. This value is expressed as a function of wavelength λ, and is related to the maximum angular sector ±θₘₐₓ through which the beam must be steered, and to the angular sector ±θ₁ that must be grating-lobe free:

$${d}_{max} < \frac{λ}{sin ( \vert {θ}_{max} \vert ) + sin ( \vert {θ}_{1} \vert )}$$

For the active antennas used in LEO satellites, these angular sectors are typically of between ±55°. The unit cell of the array, and therefore the maximum size of the radiating elements, must therefore be smaller than 0.6λ in this case.

These small radiating elements are characterized by substantial mutual coupling between the radiating elements of a given array. This mutual coupling between radiating elements, combined with the amplitude and phase feed law assigned to the various radiating elements to synthesize a beam in a given direction, is instrumental in the variation in the active impedance of the radiating elements as a function of the off-axis angle targeted for the beam. At each input port of a radiating element, the reflected signal is a result of a combination of the signal reflected by the radiating element alone and of all the signals coupled from all the adjacent radiating elements, when all the radiating elements are fed with the specified amplitude and phase law.

In certain antennas, this mismatch can even be complete in certain directions, and it is then not possible to point a beam in very off-axis directions. This is referred to as scan blindness.

The variation in the active impedance of the radiating elements also affects amplifier operation, and in particular:
AM/AM (amplitude/amplitude) linearity, i.e. variation in the ratio of output power to input power as a function of input power;
AM/PM (amplitude/phase) linearity, i.e. variation in the phase of the output signal as a function of the power of the input signal. Ideally, this phase is invariable; and
power added efficiency (PAE), i.e. the ratio of the radio-frequency power delivered to the total power absorbed.

Variation in these parameters results in a modification of the phase and amplitude law of the array antenna, and consequently in an additional disruption to beam formation.

One technical problem to be solved in this context is thus that of stabilizing the active impedance of the radiating elements of an array antenna whatever the off-axis angle of the beam.

Known solutions allowing the effect of mutual coupling between radiating elements of an array antenna to be compensated for belong to the family of WAIM devices (WAIM standing for wide-angle impedance-matching).

Prior-art WAIM devices can be classified by type, these types including fully dielectric devices, monolayer metasurfaces, multilayer metasurfaces and finally 3D devices.

### WAIM Devices Based on Dielectric Layers

The first WAIM device concept was proposed by the authors of [1]. They proposed to correct the susceptance dispersion of the active input impedance, caused by mutual coupling between the elements of the array, by means of a dielectric layer. This layer may be considered to be a pure susceptance that compensates for the dispersion in the susceptance of the elements of the array during steering.

In general, these layers are of limited efficacy, and the effect of the layer is mainly observed in H-plane scans, where the maximum off-axis angle of the antenna is improved by 27°. However, such devices are not capable of acting on the E-plane independently. Specifically, they do not have enough degrees of freedom to permit effective joint optimization in both plans. Moreover, these layers are dimensioned for a given frequency and, although they do not employ a resonant mechanism, their performance in terms of bandwidth is limited. Furthermore, since these layers are made of dielectric materials, they are limited to the available materials and have the drawbacks inherent to these materials, such as intrinsic losses, degassing in space, or high sensitivity to temperature.

### WAIM Devices Based on Monolayer and Multilayer Metasurfaces

A second type of WAIM device employs monolayer metasurfaces. These consist of a dielectric layer on which periodic metal patterns the size of which does not exceed a few tenths of a wavelength are positioned. This gives them characteristics not found in natural materials, such as negative permeability or permittivity. Above all, the artificial susceptance thus generated can be more easily adjusted to meet specific constraints in terms of angular behaviour, dispersion or isotropic properties. In practice, the main studies reported have observed an improvement in the H-plane with matching improved from θ=0° to 55° in [2], up to 80° in [3] and in the interval θ=[75°,105°] in [4].

These layers, by virtue of the employed printed patterns, have more degrees of freedom, this making it easier to optimize their performance to meet various objectives, at the cost however of a more complex development process. For example, use of a pattern having a rotational invariance of 90° will lead to identical behaviour for two orthogonal linear polarizations.

However, since these devices are based on use of a dielectric material, they also have the associated drawbacks, such as intrinsic losses, degassing in space, or high sensitivity to temperature.

The natural evolution of monolayer metasurfaces is to multilayer metasurfaces. The principle is the same as for a single layer, but the obtained performance is a little better, by virtue of the addition of new degrees of freedom. Examples of such structures are given in [5]. Having more than one layer above all gives the structure the ability to operate over a wider frequency range, because each layer is capable of operating in a specific group of frequencies. These solutions have the same drawbacks as monolayer metasurfaces and dielectric layers.

### WAIM Based on 3D Structures

A final type of WAIM device makes use of 3D structures, as for example described in [6] which presents a device combining two orthogonal printed structures, themselves positioned perpendicular to the plane of the radiating aperture (assumed horizontal by convention). The particularity of this solution is that the two orthogonal vertical layers of the device make it possible to act on the scan in the H- and E-planes relatively independently. As a result, the angular range of the E-plane scan is improved by 10° while the angular range of the H-plane scan is improved by 39°. This study shows the advantage of positioning metal elements perpendicular to the radiating surface (here vertically).

However, it fails to fully exploit this advantage for two main reasons. The first is due to the fact that the two parts of the WAIM device are vertical, this not allowing the two scan planes to be perfectly dissociated. This “coupling” effect is further accentuated here because the two orthogonal patterns are nested (the second fitting into the first with a partial overlap between the two). The second reason, which is a direct consequence of the first, is that this structure works only for a single linear polarization and cannot, by its very nature, be extended to two polarizations. Specifically, it is not possible as things stand to achieve 90° rotational invariance in the horizontal plane without losing the, albeit imperfect, capacity to independently adjust matching in the E- and H-scan planes. Finally, the structure has a complex manufacturing process in which multiple layers of partially metallized substrates are mounted orthogonally. In addition, since it employs dielectric materials, it has the same drawbacks as the aforementioned solutions.

Impedance-matching devices such as described in references [7] and [8] are also known.

These devices are a new type of wide-angle impedance-matching device based on a first transmission screen dimensioned to match the active impedance of the array antenna in the H-plane for a linearly polarized electric-field component and on addition of vertical metal pillars allowing mismatch to be cancelled out in the E-plane without any effect on the electric field in the H-plane.

### SUMMARY OF THE INVENTION

One subject of the invention is a wide-angle impedance-matching device for a radiating-element array antenna, comprising:
a transmission screen having a first surface intended to be positioned facing the radiating-element array parallel to the radiating aperture of the antenna and being configured to match the impedance of the antenna for an H-plane scan,
and a set of metal pins placed orthogonally, on at least one surface of the transmission screen, at the intersection of at least some of the respective anti-symmetry planes of the electric field radiated by the antenna for an H-plane scan, for two linear polarizations in two orthogonal directions, said set of metal pins being configured to match the impedance of the antenna for an E-plane scan.

According to one particular aspect of the invention, the transmission screen is a structure composed of one or more dielectric layers.

According to one particular aspect of the invention, the transmission screen is a structure composed of monolayer or multilayer meta-surfaces on which a periodic grid of metal patterns is placed.

According to one particular aspect of the invention, the transmission screen is a periodic grid of a plurality of cells, each cell comprising a supporting frame and at least one interconnect internal to said supporting frame, said supporting frame being inscribed in a prism, having a given axis Z′, said prism comprising [symbol] faces connected together by [symbol] edges, which are oriented along the axis of the prism Z′, said supporting frame comprising [symbol] corner elements, each corner element having an edge coinciding with one of said edges of the prism, the corner elements being arranged such that the supporting frame has, on each face of the prism, a slot extending along the axis of the prism Z′; and each internal interconnect comprises [symbol] inductive rods each comprising two ends, the inductive rods each having a first end connected to one of said edges of the supporting frame, the second ends of the inductive rods being connected to one another at a rod-connection point, said rod-connection point being positioned substantially in the centre of said supporting frame in a plane orthogonal to the axis of the prism Z′.

According to one particular aspect of the invention, the metal pins are positioned in the extension of each edge of each of the cells.

According to one particular aspect of the invention, a metal pin of said assembly is positioned on said rod-connection point.

According to one particular aspect of the invention, the metal pins are placed, at least partially, on the surface of the transmission screen opposite the first surface.

Another subject of the invention is an antenna device comprising a radiating-element array antenna the radiating elements of which are able to radiate a field of transverse electromagnetic waves, and a wide-angle impedance-matching device according to the invention and positioned on said radiating-element array.

According to one particular aspect of the invention, the wide-angle impedance-matching device is positioned at a non-zero distance from the radiating-element array.

According to one particular aspect of the invention, the wide-angle impedance-matching device is positioned in contact with the radiating-element array.

Another subject of the invention is a method for designing a wide-angle impedance-matching device according to the invention, comprising:
a first step of dimensioning the transmission screen so as to optimize impedance matching for the H-plane scan of the array antenna,
a second step of dimensioning all the metal pins so as to optimize impedance matching for the E-plane scan of the array antenna without modifying the matching previously achieved in the H-plane.

According to one particular aspect of the invention, the second step of dimensioning all of the metal pins consists at least in dimensioning the length of the pins.

According to one particular aspect of the invention, the first step of dimensioning the transmission screen consists at least in dimensioning at least one parameter among: the dimension of the inductive rods, the dimension of the slots, the position of the inductive rods along the axis of the prism Z′, and the number of internal interconnects.

According to one particular aspect of the invention, the first dimensioning step further comprises dimensioning the distance between the radiating-element array and the impedance-matching device.

### BRIEF DESCRIPTION OF THE DRAWINGS

Other features and advantages of the present invention will become more clearly apparent on reading the following description with reference to the following appended drawings.

FIG. 1 shows a schematic overview of an active antenna comprising a radiating-element array and a wide-angle impedance-matching device according to one embodiment of the invention,

FIG. 2 shows a schematic of a TEM cell,

FIG. 3 shows a schematic of a TEM cell reactively loaded by a cross-shaped interconnect,

FIG. 4 shows the TEM cell of FIG. 3 on which metal pins according to a first embodiment of the invention have been placed,

FIG. 5 shows the TEM cell of FIG. 3 on which metal pins according to a second embodiment of the invention have been placed,

FIG. 6 shows the equivalent circuit diagram of a TEM cell,

FIG. 7 shows anti-symmetry planes of the matching device for the H-plane scan and for a vertical linear polarization,

FIG. 8 shows anti-symmetry planes of the matching device for the H-plane scan and for a horizontal linear polarization,

FIG. 9 illustrates the definition of an anti-symmetry plane for an electromagnetic-wave field propagating through a guide of rectangular cross section,

FIG. 10 illustrates the definition of anti-symmetry planes for an array of TEM cells according to the invention for a linear polarization in a given direction and for an H-plane scan,

FIG. 11 illustrates the definition of symmetry planes for an array of TEM cells according to the invention for a linear polarization in a given direction and for an E-plane scan,

FIG. 12 illustrates the definition of anti-symmetry planes for a printed patch-based structure forming an impedance-matching device,

FIG. 13 shows a wide-angle impedance-matching device according to a second embodiment of the invention,

FIG. 14 shows a wide-angle impedance-matching device according to a second embodiment of the invention.

### DETAILED DESCRIPTION

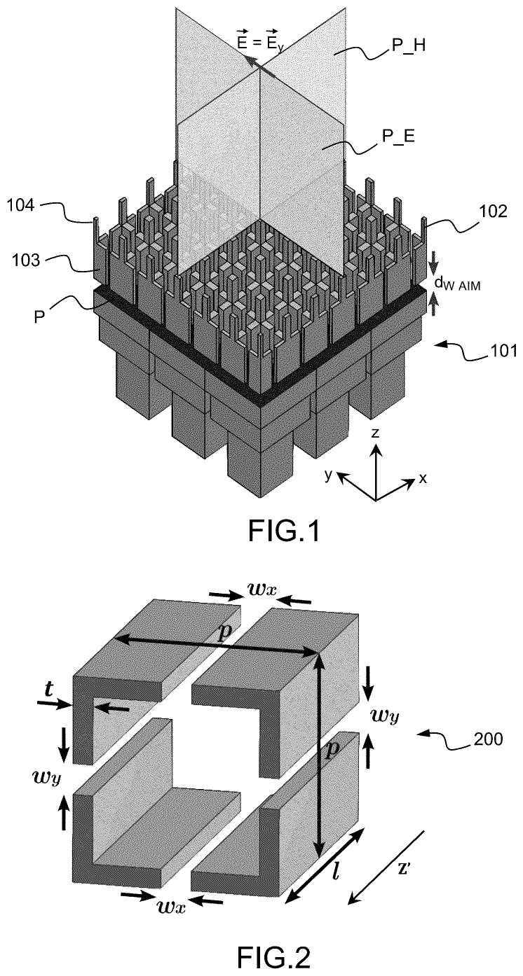

FIG. 1 shows a schematic of a wide-angle impedance-matching device according to one embodiment of the invention.

In FIG. 1 an active antenna 101 comprising a radiating-element array placed in a plane P parallel to the plane (O x y) of the reference frame has been shown. On the array, an impedance-matching device 102 is placed at a distance d_{WAIM} that may be non-zero or equal to 0.

In the case where the distance is zero, the impedance-matching device 102 is fastened in contact with the radiating-element array in the plane P. In such a case, the assembly formed by the active antenna 101 and the impedance-matching device 102 may be manufactured as a single part.

In the case where the distance d_{WAIM} is non-zero, a spacer, for example a honeycomb structure, is used to fasten the impedance-matching device 102 to the active antenna 101. The spacer is designed so as to correspond to a layer equivalent to air from the point of view of propagation of electromagnetic waves.

The matching device is designed to allow the antenna beam to be steered through a wide angular sector (at least up to 50°) while keeping the active reflection coefficient of the radiating elements below −10 dB.

The device 102 according to the invention is designed to operate in a dual linear (H and V) polarization configuration and for steering in any azimuthal plane 4.

Advantageously, the device 102 is made entirely of metal, this making it possible to keep insertion losses at a low level and to avoid the need to use potentially heavy and expensive dielectric materials, which further have the other associated drawbacks discussed above (such as vacuum degassing).

The proposed structure is three-dimensional, and hence there are many degrees of freedom available for its optimization.

It is manufacturable with metal-compatible additive manufacturing techniques (SLM for example) or, optionally, additive manufacturing techniques employing dielectric materials (SLA for example) which will then need to be metallized. Given the current capabilities of these techniques and their rapid development, a monolithic, fast and low-cost device with proven performance up to Ka band is therefore possible.

FIG. 1 schematically shows the E- and H-planes (denoted P_E and P_H) used by convention.

The device 102 consists of two cascaded elements: a periodic grid of TEM cells 103 positioned parallel to the radiating aperture of the active antenna, at a distance d_{WAIM} therefrom, and an array of metal pins 104 orthogonal to the grid (i.e. oriented in the z-direction) and sticking out from the face opposite the radiating aperture.

According to one variant embodiment, the metal pins 104 are placed facing the antenna or distributed over the two opposite faces of the grid of TEM cells.

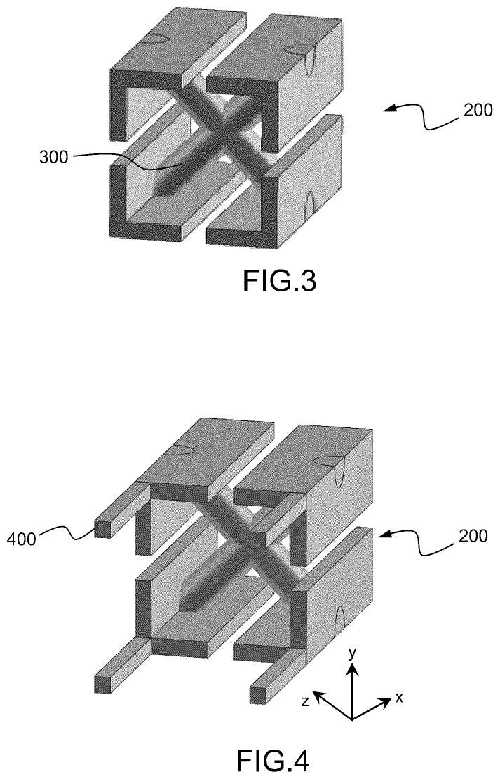

One example of a TEM cell has been shown in FIGS. 2 and 3. This TEM cell is also described in French patent application FR3095303.

FIG. 2 shows an example of a cell 200 of square cross section consisting of four metal walls of thickness t and of width p. Each wall contains a lengthwise slot having a width wₓ or w_{y} depending on the side of the cell in question.

In one variant embodiment, the cell 200 may have a cross section of different shape, hexagonal for example.

Furthermore, the cell 200 comprises a cross-shaped internal interconnect 300 allowing reactive loading, as illustrated in FIG. 3. The internal interconnect 300 is axisymmetric. It is electrically conductive so as to form an electrical discontinuity in the cell 200. The cross 300 is formed from two electrically conductive rods that form an inductive load.

In other words, each cell 200 comprises a supporting frame and one (or more than one) interconnect(s) 300 internal to the supporting frame. The supporting frame is inscribed in a prism, having a given axis Z′. In the example of FIG. 2 and of FIG. 3, the prism has a square cross section. The prism comprises [symbol] faces connected together by [symbol] edges, which are oriented along the axis of the prism Z′, the supporting frame comprising [symbol] corner elements, each corner element having an edge coinciding with one of the edges of the prism, the corner elements being arranged such that the supporting frame has, on each face of the prism, a slot extending along the axis of the prism Z′. In this example, [symbol] =4.

Each internal interconnect comprises [symbol] inductive rods each comprising two ends, the inductive rods each having a first end connected to one of said edges of the supporting frame, the second ends of the inductive rods being connected to one another at a rod-connection point, the rod-connection point being positioned substantially in the centre of the supporting frame in a plane orthogonal to the axis of the prism Z′. In the example the internal interconnect comprises four rods and is cross-shaped.

More details on the design of a TEM cell according to FIG. 3 are given in application FR3095303.

FIG. 4 shows the basic structure of the impedance-matching device of FIG. 1. This structure is composed of a TEM cell 200 on which metal pins 400 are placed at the four corners of the cell. The metal pins are placed orthogonally to the xOy plane, which is parallel to the transverse plane of the cell and to the radiating aperture of the antenna. Advantageously, the metal pins are rods of constant circular or square cross section having predetermined dimensions.

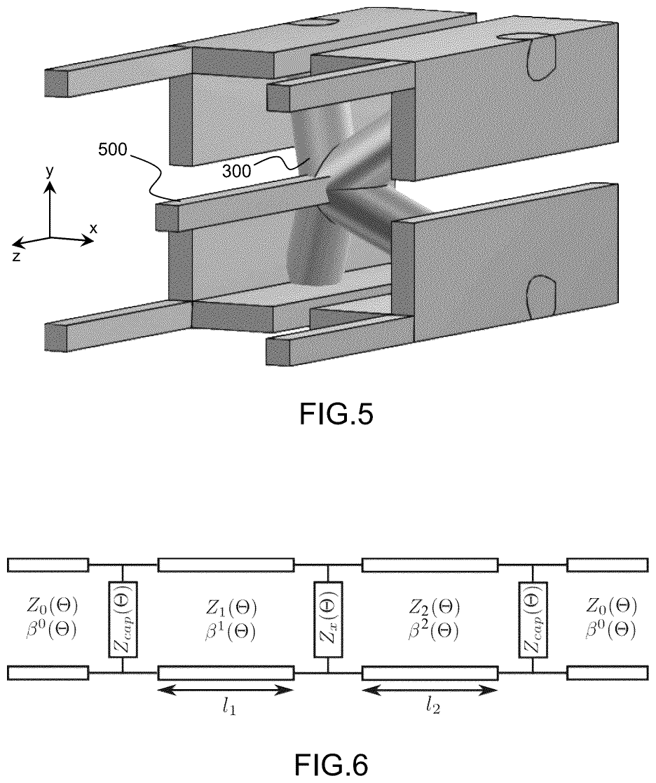

FIG. 5 shows a variant embodiment of the structure of FIG. 4, in which an additional metal pin 500 has been placed at the centre of the cell fastened to the internal interconnect 300. In this case, the internal interconnect structure 300 has a pyramidal shape, i.e. the interconnect rods forming the arms of the cross make a non-zero angle to the transverse xOy plane of the cell. This shape is in particular chosen when the device is manufactured by an additive manufacturing technique.

The degrees of freedom used to optimize the structure operation are in particular:
its position with respect to the radiating aperture (distance d_{WAIM}); the geometric parameters of the grid (length, spacing of the conductive planes and, to a lesser extent, their thickness);
the geometry of the reactive pattern itself and its position within the cell, i.e. the geometry of the interconnect 300 and its position; and
the length of the metal pins and, to a lesser extent, their diameter.

The constraints to be met when configuring the structure are:
geometry of 90° rotational invariance, to guarantee identical operation for both horizontal (H) and vertical (V) linear polarizations;
use of a reactive pattern (interconnect structure 300) the structure of which ensures the mechanical cohesion of the grid at the same time as allowing matching.

According to one variant of embodiment of the invention, it is not essential for the periodicity of the grid of TEM cells to coincide with the periodicity of the radiating-element array. For example, a grid of TEM cells of period corresponding to a sub-multiple of the period of the array antenna (i.e., such a period of the array coincides with an integer number of periods of the grid) has the advantage of averting any additional difficulties in respect of avoidance of grating lobes. The potential of the TEM cell in terms of miniaturization (due to the absence of cut-off frequency for modes propagating through the cell) facilitates such an option.

Generally, and as illustrated in FIG. 1, the metal pins are placed on the grid of TEM cells so as to be at the intersection of the respective anti-symmetry planes of the electric field radiated by the antenna for an H-plane scan, for two different (horizontal and vertical) linear polarizations. This point will be explained in more detail below.

The device according to the invention is dimensioned so as to dissociate the impedance matching required for an H-plane scan of the antenna from the impedance matching required for an E-plane scan of the antenna, for two orthogonal linear polarizations.

Thus, the device according to the invention may be designed using a two-phase design method.

The first design phase consists in dimensioning the grid of TEM cells so as to optimize the impedance matching required for the H-plane scan. This optimization consists in adjusting at least one parameter among the position d_{WAIM} of the grid with respect to the radiating aperture, its dimensions, the geometric pattern, and the dimensions of the interconnect structure reactively loading the cell. The optimization is carried out so as to give the TEM cell an input impedance such as to minimize the active reflection coefficient of the ports of the antenna, whatever the off-axis angle in this plane. The multiplicity of the available degrees of freedom means that there are many ways of achieving this matching.

For example, this first optimization phase is performed by means of an equivalent electrical circuit. The impedance-matching device is modelled as a load at a distance d_{WAIM} from the antenna. One objective of the optimization is to determine the load for which the active reflection coefficient of the antenna is minimum in the considered interval of off-axis angles, optionally in a given frequency range. Once the desired load has been determined, it is synthesized into a real component.

FIG. 6 shows one example of an equivalent circuit diagram of a TEM cell of the type illustrated in FIG. 3.

The interconnect structure 300 reactively loading the cell is modelled by an impedance Zₓ(θ), where θ is the off-axis angle. On each side of this structure, two sections of the TEM cell of respective lengths l₁ and l₂ have been modelled by transmission lines of parameters Z₁(θ), β₁(θ), Z₂(θ), δ₂(θ).

The impedances Z_{cap}(θ) model the effect of discontinuities between the ends of the cell and air. The impedances Z₀(θ) correspond to propagation of the waves through free space.

The dimensioning parameters of the cell are, in particular, the sizes of the inductive rods of the interconnect structure, their diameter, the width of the slots in the walls of the cell, and the lengths l₁ and l₂.

In one alternative embodiment, a plurality of interconnect structures may be placed in cascade to form a plurality of reactive loads and increase the number of optimization parameters.

In the second design phase, the addition of orthogonal metal pins to the optimized grid does not modify the matching already achieved for the H-plane, as long as the pins are placed in the anti-symmetry planes of the structure associated with this H-plane scan. Specifically, the fact that the tangential component of the electric field is necessarily zero in such planes guarantees that placing a perfect conductor at this point will not modify the field distribution observed for the grid alone. In contrast, such a conductor will have a non-negligible effect on the field distribution for an E-plane scan, since the planes of anti-symmetry are not the same for this scan. Consequently, the introduced conductor may be used to optimize matching in the E-plane, without modifying the matching achieved beforehand in the H-plane by virtue of the grid of cells alone.

In conclusion, optimization of the grid of TEM cells and of the load thereon allows the H-plane scan to be matched. This is the first phase of the design method. Subsequent optimization of the metal pins then allows impedance to be matched in the E-plane, without degrading the matching achieved beforehand for the H-plane. This is the second phase of the design method.

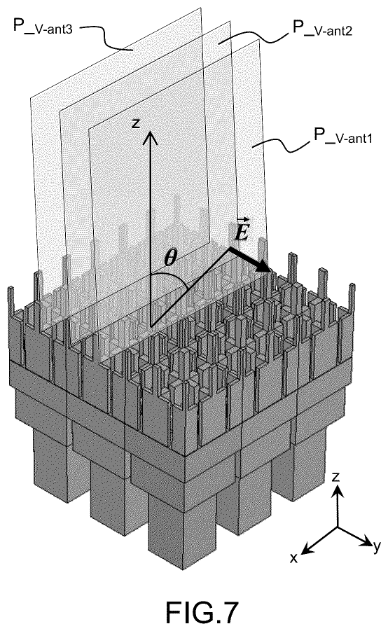

FIG. 7 shows several anti-symmetry planes P__{V-ant1}, P__{V-ant2}, P__{V-ant3} of the grid of TEM cells for the H-plane scan and for a vertical (V) linear polarization (along the y-axis). These anti-symmetry planes are planes perpendicular to the electric field E and therefore parallel to the xOz plane passing through the corners of the cells or through their centres. In theory, a perfect conductor intended to impedance match an E-plane scan can be placed anywhere in these planes without modifying the optimization achieved for the H-plane.

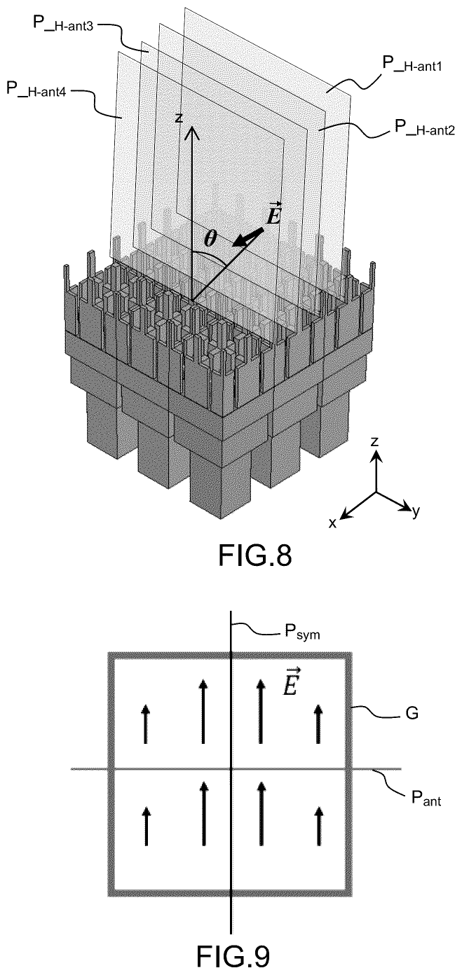

FIG. 8 shows several anti-symmetry planes P__{H-ant1}, P__{H-ant2}, P__{H-ant3}, P__{H-ant4}, this time for a horizontal (H) linear polarization (along the x-axis). These planes are this time parallel to the yOz plane passing through the corners of the cells or their centres.

Thus, to remain compatible with both vertical and horizontal linear polarizations, the metal pins must be placed at the intersection of the anti-symmetry planes associated with the vertical polarization (which are shown in FIG. 7) and the anti-symmetry planes associated with the horizontal polarization (which are shown in FIG. 8). It is for this reason that metal blades extending over an entire side of a cell in an anti-symmetry plane for one of the two polarizations do not meet this condition and do not allow dual polarization operation to be ensured.

Likewise, to ensure dual polarization operation, it is also necessary for the interconnect structure reactively loading the cell to be axisymmetric. A cross-shaped structure such as shown in FIGS. 4 and 5 has this property.

The impedance-matching device described above may be manufactured entirely from metal, for example using an all-metal additive manufacturing process, or from dielectric materials that are subsequently metallized. This has the advantage of decreasing manufacturing costs, of decreasing losses, and of eliminating the drawbacks associated with using a dielectric material when the device is manufactured directly from metal.

The device is dimensioned in two steps, as introduced above:
a first step of dimensioning the grid of TEM cells so as to impedance match the H-plane scan of the array antenna; and
a second step of dimensioning the metal pins (essentially their lengths and their diameters) so as to impedance match the E-plane scan while achieving transparency in the H-plane.

One important constraint that must be met to ensure independence of the respective H-plane and E-plane optimizations is that the metal pins must be placed in anti-symmetry planes for both, horizontal and vertical, linear polarizations.

FIG. 9 illustrates, for a simple example of an electromagnetic field E propagating through a waveguide G of square or rectangular cross section, the definition of a symmetry plane P_{sym}, and of an anti-symmetry plane Pₐₙₜ. The electric field has been represented schematically by arrows of length proportional to its amplitude.

The symmetry plane P_{sym} is a plane for which two conditions are simultaneously met:
the cross section of the waveguide is symmetrical with respect to the plane P_{sym}; and
the electric field is symmetrical with respect to the plane P_{sym}, i.e. the vector of the electric field E has reflection symmetry with respect to this plane.

The anti-symmetry plane Pₐₙₜ is a plane for which two conditions are simultaneously met:
the cross section of the waveguide is symmetrical with respect to the plane Pₐₙₜ; and
the electric field is anti-symmetrical with respect to the plane Pₐₙₜ, i.e. the vector of the electric field E has reflection symmetry when also flipped with respect to this plane.

The anti-symmetry plane Pₐₙₜ corresponds to a perfect electrical conductor, i.e. a conductor may be placed therein without changing the configuration of the electric field.

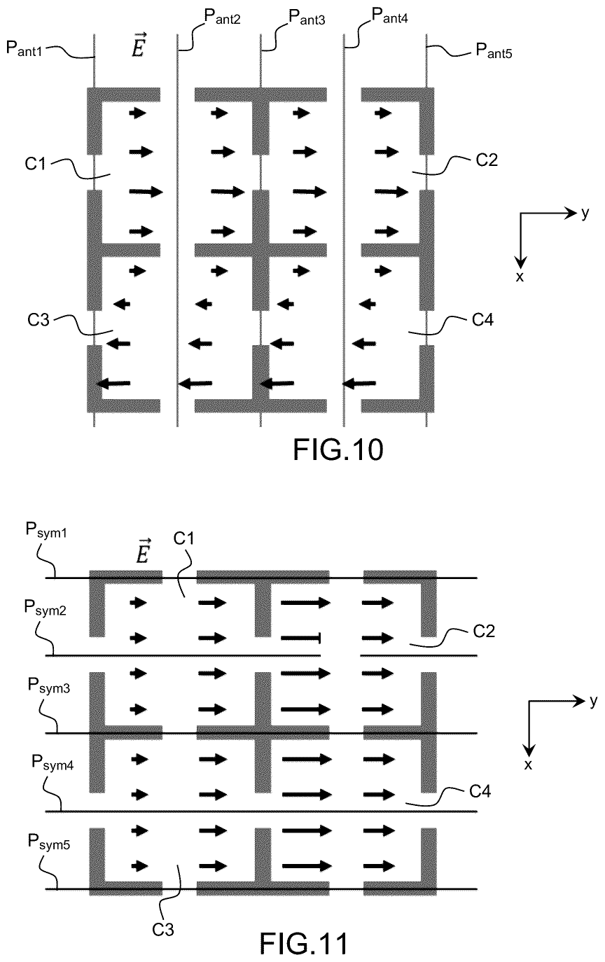

FIGS. 10 and 11 illustrate the definition of anti-symmetry planes for the grids of TEM cells according to the invention.

FIG. 10 shows one example, seen from above, of a grid of four TEM cells C₁, C₂, C₃, C₄ for a scan in the H-plane (xOz plane) and for a polarization of the wave along the Oy axis.

This structure has five anti-symmetry planes Pₐₙₜ₁, Pₐₙₜ₂, Pₐₙₜ₃, Pₐₙₜ₄, Pₐₙₜ₅ that pass through the sides and centres of the cells and are parallel to the Ox axis.

Specifically, the electric field E varies in phase along the Ox axis. It is identical in both (left and right) halves of a given cell and in two consecutive cells of a given row. In other words, the distribution of the electric field is identical in cells C₁ and C₂ on the one hand and in cells C₃ and C₄ on the other hand. The anti-symmetry planes are therefore planes along the Ox axis.

FIG. 11 shows, in the same example of a grid of four TEM cells, the distribution of the electric field for a scan in the E-plane (xOy plane) again for a polarization of the wave along the Oy axis.

In this case, the electric field varies in phase along the Oy axis. It is the same in both (top and bottom) halves of a given cell and in two consecutive cells of a given column. In other words, the electric field is identical in cells C₁ and C₃ on the one hand and in cells C₂ and C₄ on the other hand. The planes P_{sym1}, P_{sym2}, P_{sym3}, P_{sym4}, P_{sym5} are symmetry planes. There is no anti-symmetry plane in this configuration.

In the case where the wave is polarized along the Ox axis, the symmetry planes illustrated in FIG. 11 become anti-symmetry planes.

Without departing from the scope of the invention, the array of TEM cells may be replaced by a prior-art impedance-matching device based, for example, on monolayer or multilayer metasurfaces.

Whatever the basic device chosen to match impedance for the H-plane scan, the metal pins allowing impedance to be matched for the E-plane scan must be placed at the intersection of the anti-symmetry planes for both polarizations.

Such planes of anti-symmetry are defined depending on the chosen structure.

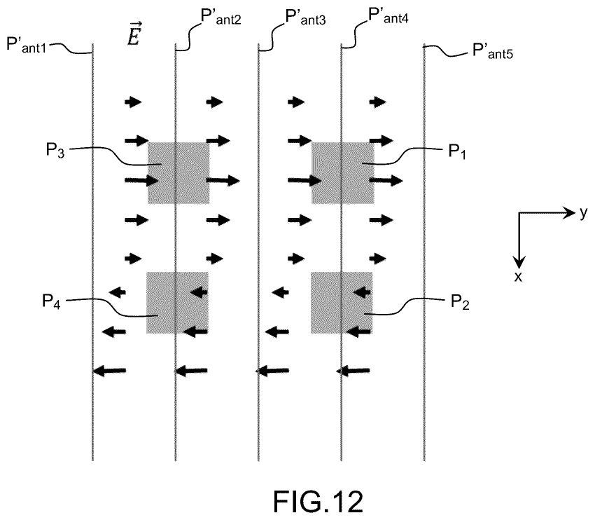

FIG. 12 shows five anti-symmetry planes P′ₐₙₜ₁, P′ₐₙₜ₂, P′ₐₙₜ₃, P′ₐₙₜ₄, P′ₐₙₜ₅ for a printed structure based on patches P1, P2, P3, P4, again for a polarization along the Oy axis. The variation in the electric field has also been shown, in the form of arrows.

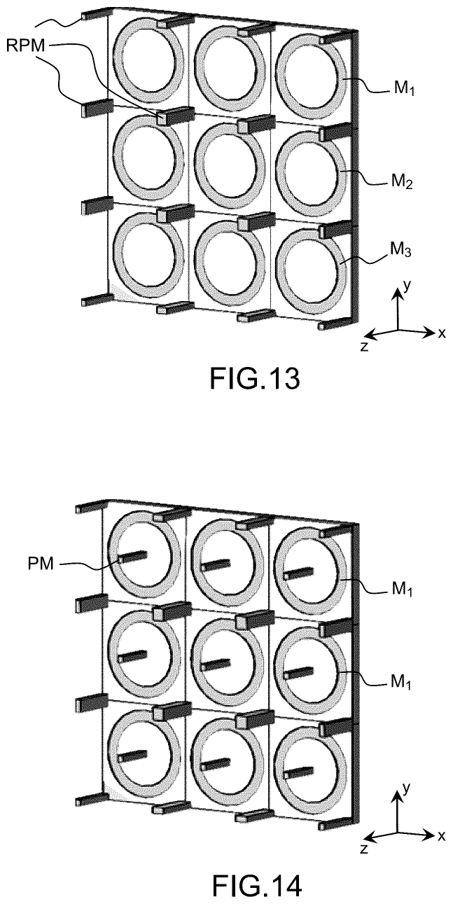

The anti-symmetry planes for a polarization along the Ox axis are obtained by applying a rotation of 90° to the anti-symmetry planes of FIG. 13.

The impedance-matching device for the H-plane scan may also be a structure composed of one or more dielectric layers.

FIG. 13 shows a second embodiment of the invention in which the TEM cells have been replaced by structures based on metasurfaces comprising at least one dielectric layer on which periodic metal patterns M₁, M₂, M₃ have been positioned. The set of patterns forms a grid the dimensions and parameters of which are chosen so as to match the impedance of the antenna for the H-plane scan.

A metal pin array RPM is then placed orthogonally to the grid of patterns. The metal pins are placed at the intersection of the anti-symmetry planes of the electric field, for the H-plane scan, and for the two linear polarizations along the x- and y-axes.

The metal pin array RPM, and in particular the length of the pins, is optimized to match the impedance of the antenna for the E-plane scan.

FIG. 14 shows a variant of the embodiment of the invention illustrated in FIG. 13. In this variant, additional metal pins PM are positioned at the centres of each pattern, which also belong to the anti-symmetry planes of the electric field for the two linear polarizations along the x- and y-axes.

### REFERENCES

[1] E. Magill and H. Wheeler, “Wide-angle impedance matching of a planar array antenna by a dielectric sheet”, IEEE Transactions on Antennas and Propagation, vol. 14, no. 1, pp. 49-53, January 1966
[2] S. Sajuyigbe, M. Ross, P. Geren, S. Cummer, M. Tanielian, and D. Smith, “Wide angle impedance matching metamaterials for waveguide-fed phased-array antennas”, IET Microwaves, Antennas & Propagation, vol. 4, 8, p. 1063, 2010
[3] G. Oliveri, M. Salucci, N. Anselmi, and A. Massa, “Multiscale system-by-design synthesis of printed WAIMs for waveguide array enhancement”, IEEE Journal on Multiscale and Multiphysics Computational Techniques, vol. 2, pp. 84-96, 2017
[4] G. Oliveri et al., “Wide-Angle Impedance Matching Layer-Enhanced Dual-Polarization sub-6 GHz Wide-Scan Array for Next-Generation Base Stations”, IEEE Trans. Antennas Propag., vol. 70, no. 7, pp. 5506-5520, July 2022
[5] W. H. Syed, D. Cavallo, H. Thippur Shivamurthy, and A. Neto, “Wideband, widescan planar array of connected slots loaded with artificial dielectric superstrates”, IEEE Transactions on Antennas and Propagation, vol. 64, 2, pp. 543-553, February 2016
[6] B. Sun, R. Loison, R. Gillard, E. Estebe, and C. Renard, “3d wide-angle impedance matching for x-band phased array”, in 2021 15th European Conference on Antennas and Propagation (EuCAP), Dusseldorf, Germany: IEEE, Mar. 22, 2021
[7] Enhancement of impedance matching using longitudinal blades and pins: Y. Zhang, A. R. Vilenskiy and M. V. Ivashina, “Mutual Coupling Analysis of Open-Ended Ridge and Ridge Gap Waveguide Radiating Elements in an Infinite Array Environment”, 52nd European Microwave Conference (EuMC), 2022, pp. 696-699, doi: 10.23919/EuMC54642.2022.9924388.
[8] Enhancement of impedance matching using longitudinal slits: X. Liang, Z. Zhang, J. Zeng, F. Guan, X. Liu and J. Zi, “Scan Blindness Free Design of Wideband Wide-Scanning Open-Ended Waveguide Phased Array”, IEEE Access, vol. 9, pp. 68127-68138, 2021, doi: 10.1109/ACCESS.2021.3074867.

1. A wide-angle impedance-matching device for a radiating-element array antenna, comprising:
a transmission screen having a first surface intended to be positioned facing the radiating-element array parallel to the radiating aperture of the antenna and being configured to match the impedance of the antenna for an H-plane scan,
and a set of metal pins placed orthogonally, on at least one surface of the transmission screen, at the intersection of at least some of the respective anti-symmetry planes of the electric field radiated by the antenna for an H-plane scan, for two linear polarizations in two orthogonal directions (P__{V-ant1}, P__{V-ant2}, P__{V-ant3}, P__{H-ant1}, P__{H-ant2}, P__{H-ant3}), said set of metal pins being configured to match the impedance of the antenna for an E-plane scan.

2. The wide-angle impedance-matching device according to claim 1, wherein the transmission screen is a structure composed of one or more dielectric layers.

3. The wide-angle impedance-matching device according to claim 1, wherein the transmission screen is a structure composed of monolayer or multilayer meta-surfaces (P₁, P₂, P₃, P₄) on which a periodic grid of metal patterns is placed.

4. The wide-angle impedance-matching device according to claim 1, wherein the transmission screen is a periodic grid of a plurality of cells, each cell comprising a supporting frame and at least one interconnect internal to said supporting frame, said supporting frame being inscribed in a prism, having a given axis Z′, said prism comprising [symbol] faces connected together by [symbol] edges, which are oriented along the axis of the prism Z′, said supporting frame comprising [symbol] corner elements, each corner element having an edge coinciding with one of said edges of the prism, the corner elements being arranged such that the supporting frame has, on each face of the prism, a slot extending along the axis of the prism Z′; and in that each internal interconnect comprises [symbol] inductive rods each comprising two ends, the inductive rods each having a first end connected to one of said edges of the supporting frame, the second ends of the inductive rods being connected to one another at a rod-connection point, said rod-connection point being positioned substantially in the centre of said supporting frame in a plane orthogonal to the axis of the prism Z′.

5. The wide-angle impedance-matching device according to claim 4, wherein the metal pins are positioned in the extension of each edge of each of the cells.

6. The wide-angle impedance-matching device according to claim 4, wherein a metal pin of said assembly is positioned on said rod-connection point.

7. The wide-angle impedance-matching device according to claim 1, wherein the metal pins are placed, at least partially, on the surface of the transmission screen opposite the first surface.

8. An antenna device comprising a radiating-element array antenna the radiating elements of which are able to radiate a field of transverse electromagnetic waves, and a wide-angle impedance-matching device according to claim 1 and positioned on said radiating-element array.

9. The antenna device according to claim 8, wherein the wide-angle impedance-matching device is positioned at a non-zero distance from the radiating-element array.

10. The antenna device according to claim 8, wherein the wide-angle impedance-matching device is positioned in contact with the radiating-element array.

11. A method for designing a wide-angle impedance-matching device according to claim 1, comprising:
a first step of dimensioning the transmission screen so as to optimize impedance matching for the H-plane scan of the array antenna,
a second step of dimensioning all the metal pins so as to optimize impedance matching for the E-plane scan of the array antenna without modifying the matching previously achieved in the H-plane.

12. The method for designing an impedance-matching device according to claim 11, wherein the second step of dimensioning all of the metal pins consists at least in dimensioning the length of the pins.

13. The method for designing an impedance-matching device according to claim 11, wherein the transmission screen is a periodic grid of a plurality of cells, each cell comprising a supporting frame and at least one interconnect internal to said supporting frame, said supporting frame being inscribed in a prism, having a given axis Z′, said prism comprising [symbol] faces connected together by [symbol] edges, which are oriented along the axis of the prism Z′, said supporting frame comprising [symbol] corner elements, each corner element having an edge coinciding with one of said edges of the prism, the corner elements being arranged such that the supporting frame has, on each face of the prism, a slot extending along the axis of the prism Z′; and in that each internal interconnect comprises [symbol] inductive rods each comprising two ends, the inductive rods each having a first end connected to one of said edges of the supporting frame, the second ends of the inductive rods being connected to one another at a rod-connection point, said rod-connection point being positioned substantially in the centre of said supporting frame in a plane orthogonal to the axis of the prism Z′, and
wherein the first step of dimensioning the transmission screen consists at least in dimensioning at least one parameter among: the dimension of the inductive rods, the dimension of the slots, the position of the inductive rods along the axis of the prism Z′, and the number of internal interconnects.

14. The method for designing an antenna device comprising a radiating-element array antenna the radiating elements of which are able to radiate a field of transverse electromagnetic waves, and a wide-angle impedance-matching device according to claim 1 and positioned on said radiating-element array;
the method comprising executing a method for designing a wide-angle impedance-matching device according to claim 1, comprising:
a first step of dimensioning the transmission screen so as to optimize impedance matching for the H-plane scan of the array antenna,
a second step of dimensioning all the metal pins so as to optimize impedance matching for the E-plane scan of the array antenna without modifying the matching previously achieved in the H-plane,
wherein the first dimensioning step further comprises dimensioning the distance between the radiating-element array and the impedance-matching device.
